(19) United States
(12) Patent Application Publication
(10) Pub. No.: US 2006/0272236 A1
(43) Pub. Date: Dec. 7, 2006

(54) Insulated glass assembly

(75) Inventors: Richard A. Williams, Hendersonville, TN (US); Jason T. Dorris, Murfreesboro, TN (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: ODL, Incorporated

(21) Appl. No.: 11/128,825

(22) Filed: May 13, 2005

(51) Int. Cl. E06B 9/01

(52) U.S. Cl. 52/204.6

(57) ABSTRACT

An insulated glass assembly includes both a window covering and a decorative structure. The window covering is sandwiched between first and second glass panels, and the decorative structure is sandwiched between second and third glass panels. An inner frame half and an outer frame half support the IG assembly in a wall or a door. The frame halves include an integral valance panel that extends over a portion of one of the glass panels to cover the blind when the blind is in the raised position. In one embodiment, the decorative structure is a decorative glass panel that includes a decoration centered within the panel.

### BACKGROUND OF THE INVENTION

The present invention relates to insulated glass assemblies, and more particularly to an insulated glass assembly including both a decorative panel and a blind.

Insulated glass blind assemblies (“IG blinds”) are well known for attractively integrating a window covering, such as a blind, into a window assembly. IG blinds generally include a blind sandwiched between two glass panels. The blind is supported by a spacer that is sealed to both of the panels to form an airtight enclosure for the blind. The slats of the blind are movable between a lowered position that extends approximately the length of the glass panels, and a raised position. An inner frame and an outer frame support the IG blind assembly in place within a support structure, such as a wall or a door. An operator may be provided on the exterior surface of one of the glass panels or one of the frames that enables a user to actuate the blind between the raised and lowered positions.

Decorative glass assemblies are also well known. These assemblies commonly include a pair of non-decorative glass panels sandwiching a decorative structure such as a decorative glass panel. The decorative glass panel includes one of a variety of decorations, such as a stained glass portion or a decorative inlay. The decorative panel is typically supported about its periphery by a spacer that is sealed to each of the non-decorative panels to provide an airtight enclosure for the decorative panel.

Difficulties arise when consumers desire both a decorative glass and a blind assembly in the same location. Unfortunately, both insulated blind assemblies and decorative glass assemblies are currently manufactured and distributed as mutually exclusive products. This forces consumers who want a blind assembly covering a decorative glass unit to hang an off-the-shelf blind over the decorative glass assembly. This arrangement often does not provide the aesthetic qualities that consumers desire.

### SUMMARY OF THE INVENTION

The aforementioned problems are overcome by the present invention, wherein both an IG assembly and a decorative structure are included in a single insulated glass assembly.

In one embodiment, the present invention includes three non-decorative glass panels. A blind assembly is sandwiched between the first and second glass panels, and a decorative structure assembly is sandwiched between the second and third glass panels. The blind assembly and the decorative structure assembly are hermetically sealed between their respective panels. An inner frame and an outer frame support the assembly within a support structure, such as a wall or a door.

In another embodiment, the assembly includes a valance panel that extends over a portion of an IG assembly to cover the blind when the blind is in the raised position. The valance panel may be included in both the inner and outer frames, and may be molded integrally with the frames.

In a further refinement of this embodiment, the decorative structure is a decorative panel that includes a pattern that is centered in the offset opening. For instance, if the valance panel extends down over a top portion of the IG assembly, the pattern is centered in the visible portion of the IG assembly.

The present invention provides the benefits of an IG assembly and a decorative assembly in a single unit. Both the blind assembly and the decorative assembly are sealed within the assembly. The assembly is cost effective and provides enhanced insulation. The valance panels hide the raised blind to enhance the aesthetics, as does the positioning of the pattern in view of the valance panels.

These and other objects, advantages, and features of the invention will be more fully understood and appreciated by reference to the description of the current embodiments and the drawings.

### BRIEF DESCRIPTION OF THE DRAWINGS

FIG. 1 is a front view of an insulated glass assembly according to one embodiment of the present invention.

FIG. 2 is a cross sectional view of the present invention along line 2.

FIG. 3 is an exploded perspective view of the present invention.

FIG. 4 is an exploded top view of the present invention according to another embodiment.

FIG. 5 is an exploded side view of the present invention according to the FIG. 4 embodiment.

### DESCRIPTION OF THE CURRENT EMBODIMENTS

I. Overview

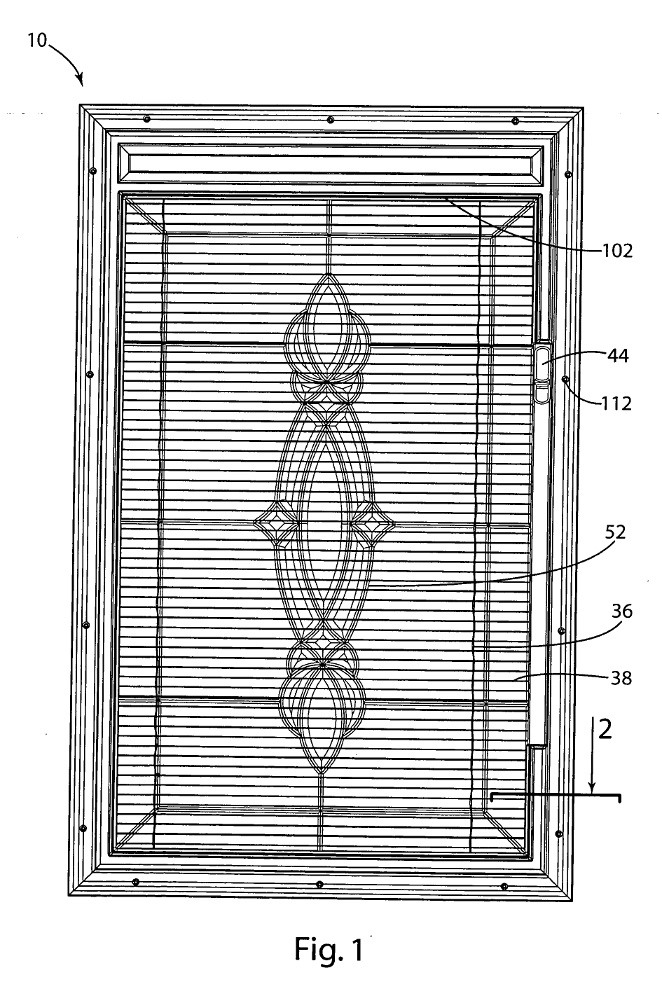

An insulated glass assembly according to one embodiment of the present invention is shown in FIGS. 1-3, and generally designated 10. The assembly generally includes first 20, second 22, and third 24 non-decorative panels, a blind 30 sandwiched between the first and second non-decorative panels, a decorative panel 50 sandwiched between the second and third non-decorative panels, and inner 60 and outer 62 frame halves connected together about the first and third non-decorative panels.

II. Structure

The non-decorative or glazed panels 20, 22, and 24 can be any translucent or transparent material known in the art. In the disclosed embodiment, each non-decorative panel 20, 22, 24 is made of glass approximately an eighth (⅛) of an inch thick, although any thickness could be used. Alternatives include Lowe safety glass, plastic, such as polycarbonate, or any other transparent, tinted or translucent material. In addition, portions of the panels 20, 22, and 24 may be conventionally silk screened or otherwise covered to prevent viewing of unsightly features within the assembly 10. For instance, portions of the perimeter edges of the panels 20, 22, and 24 may be silk screened to prevent viewing of the rear surfaces of the frame halves 60, 62.

The blind 30 is generally conventional, and therefore will not be described in great detail. Suffice it to say that the blind 30 includes a top rail 32, a bottom rail 34, and a plurality of cords 36 extending between the rails 32 and 34 carrying a plurality of slats 38. The blind 30 may further include a left spacer 40, and a right spacer 42 extending perpendicular to the slats 38. As shown, the right spacer 42 is slightly larger than the left spacer 40 for the routing of some of the cords 36 that are used for raising and lowering the slats 38. In another embodiment, the left spacer 40 may be the same larger size as the right spacer 42 to make the viewing area symmetric and prevent viewing of unsightly interior features of the assembly 10, such as the interior surfaces of the frame halves 60, 62. The cords 36 may be actuated to move the slats 38 between a raised position wherein all of the slats 38 are pulled proximate to the top rail 32 and a lowered position wherein the slats 38 are approximately evenly spaced over the area between the glass panels 20 and 22. The cords 36 may further be actuated to conventionally rotate the slats 38 open and closed. An operator 44 is located along the right spacer 42 and may be translated up and down along a track (not shown) to consequently pull the cords 36 to both (1) move the slats 38 between the raised and lowered position, and (2) rotate the slats 38 open and closed. In one embodiment, the operator is connected to the cords such that the slats 38 move completely from the lowered position to the raised position when the operator travels less than the full length of the track. In another embodiment (not shown), the operator 44 is actuated only to raise and lower the slats, and a second operator is included to rotate the slats 38 open and closed. In the illustrated embodiment, the operator 44 extends through the first non-decorative panel 20 to enable accessibility by users.

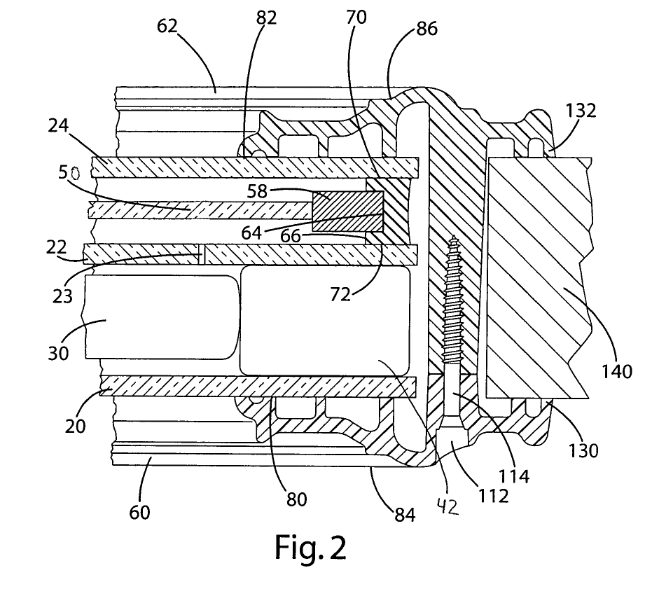

As shown in FIG. 2, the blind 30 is sandwiched between the first 20 and second 22 non-decorative panels. The blind 30 is conventionally attached to the panels, for instance, by an adhesive applied between the top rail 32, the left and right spacers 40 and 42, and the first and second panels 20 and 22. The blind 30 is preferably sealed to the first 20 and second 22 glass panels to form an airtight enclosure for the blind. The adhesive applied between the blind 30 and the panels 20 and 22 may be any adhesive known in the art. In one embodiment, the adhesive is a polysulfide adhesive.

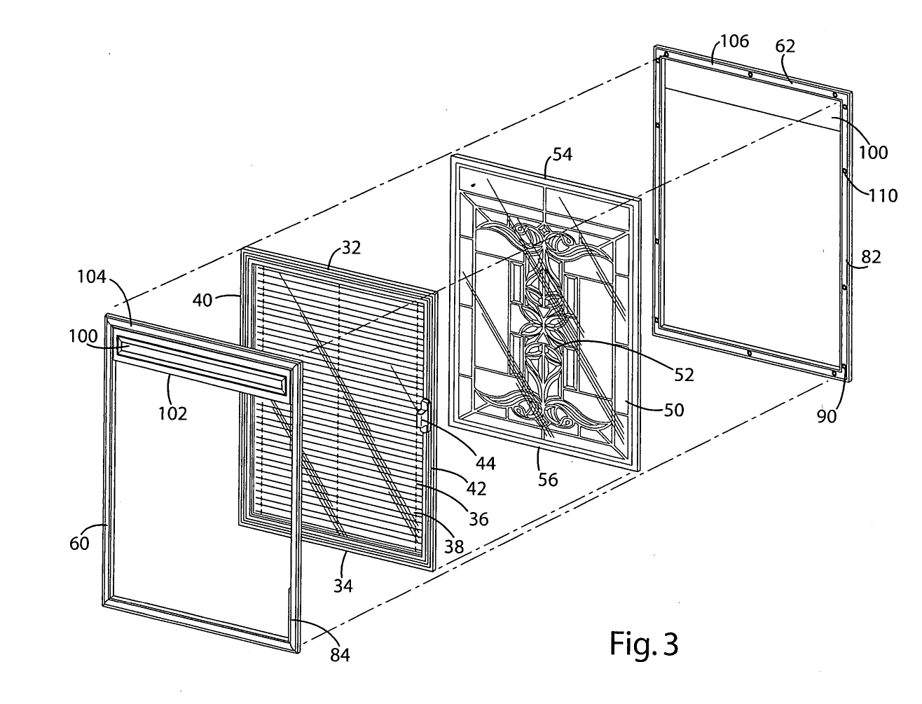

The decorative panel 50 is also conventional and is approximately the same size and thickness as the panels of non-decorative glass. A wide variety of decorative panels may be used, such as many known types of decorative glass, stained glass, and beveled glass. In addition, alternative decorative materials, such as plastic, metals, ceramics and safety glass may also be used. As shown, the panel includes a number of metal cames that divide the panel into sections, and a decoration 52 positioned in the glass. The decoration 52 may be formed with additional metal cames having desired patterns, or with beveled sections or other known decorative applications. As shown in FIG. 3, the decoration 52 may be positioned in a particular location on the decorative panel 50 to avoid being covered or hidden by portions of the frames 60, and 62 such as the valance panel 100 described below, and to be centered within the visible portion of the decorative panel. In the illustrated embodiment, the decorative panel 50 includes a top edge 54, and the decoration 52 is spaced downwardly from the top edge 54. As described below, the decoration is spaced at a distance from the top edge 54 such that it is centered between a bottom edge of the valance panel 100 and the bottom edge 56 of the decorative panel 50. In another embodiment (not shown), the decoration may similarly be spaced from the side edges or the bottom edge to center the decoration in the visible portion of the decorative panel and prevent the decoration 52 from being hidden behind portions of the frames 60, 62 or the blind assembly 30.

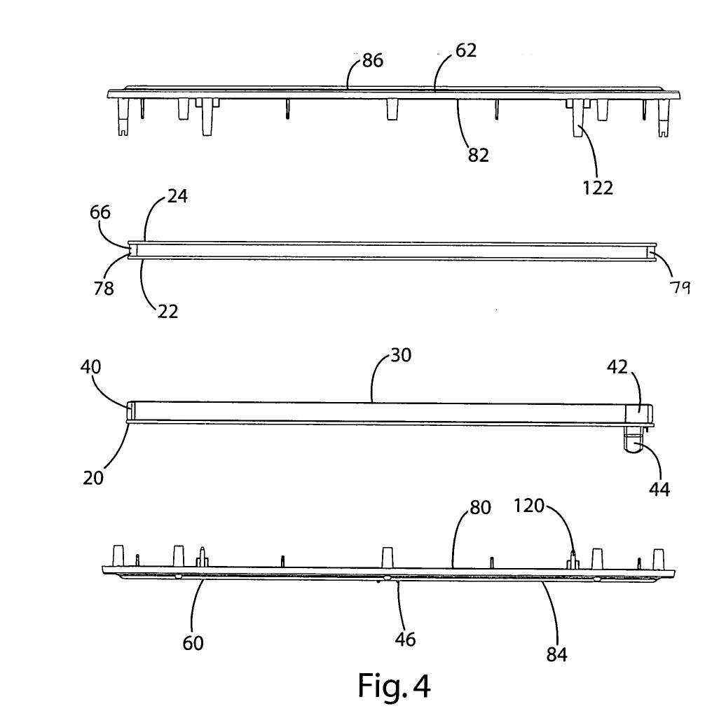

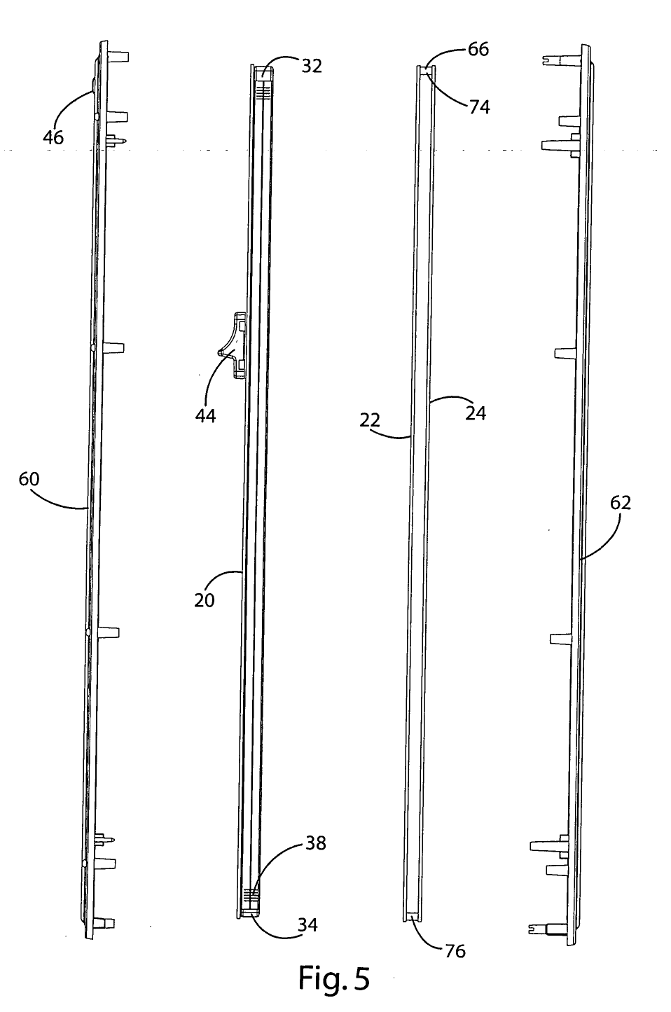

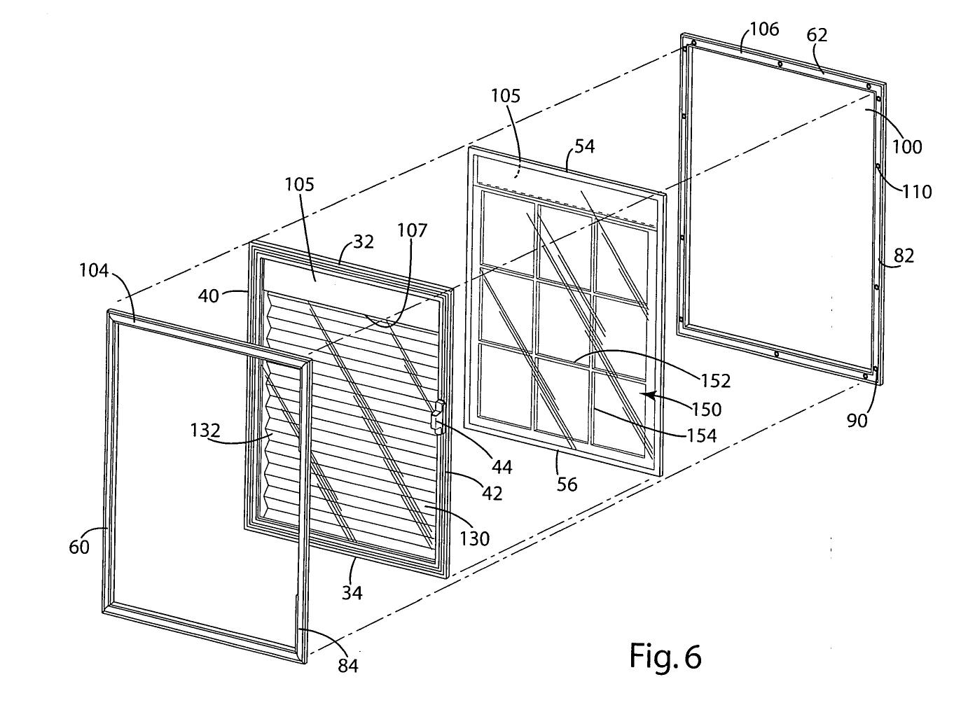

As shown in FIG. 2, the perimeter of the decorative panel 50 is held by a frame 58 that extends around the perimeter of the decorative panel 50. The frame 58 is conventional, and may be comprised of a variety of materials, such as metal. The frame 58 includes an outer edge 64 that is held by a spacer 66. The spacer 66 may be a metal or plastic structure that is held in place by a thermoplastic, such as polybutylene, molded about the perimeter of the spacer 66 to attach the spacer 66 to the frame 58. As shown in FIGS. 4 and 5, the spacer 66 includes a top member 74, a bottom member 76, and a pair of side members 78, 79. For purposes of illustration, the top member 74 is removed from FIG. 4 in order to show the side members 78, 79, and a side member 78 is removed from FIG. 5 to show the top and bottom members 74, 76. Similar to the attachment of the blind 30, the decorative panel 50 is sealed between the second 22 and third panels 24 by an adhesive material such as polysulfide. The adhesive may be applied between the outer edges 70, 72 of the spacer 66 to form an airtight enclosure for the decorative panel 50 between the second 22 and third 24 non-decorative panels. For purposes of illustration, the decorative panel 50 is not actually shown in FIGS. 4 and 5. As further shown in FIG. 2, in the embodiment including a decorative panel 50 sealed between the second 22 and third 24 non-decorative panels, the second panel 22 may include a small hole 23 through the panel 50. The hole 23 is provided to equalize the air pressure within the assembly 10.

The frame halves 60 and 62 connect together about the perimeter of the first 20 and third 24 non-decorative panels. Each frame half 60, 62 includes an interior surface 80, 82 and an exterior surface 84, 86 respectively. The frame halves may be made from a variety of known materials. In the illustrated embodiment, each frame half 60, 62 is injection molded as a single plastic piece. Shown in FIGS. 1 and 3, one or both of the frame halves may also include a valance panel 100 that extends over a portion of the first 20 and/or third 24 non-decorative panels. The valance panel 100 includes a bottom edge 102 that extends over a portion of the non-decorative panels 22, 24 a sufficient distance to cover the blind 30 when the slats 38 are in the raised position. The valance panel 100 may be integrally molded with each frame half 60, 62. In the illustrated embodiment, both frame halves include a top member 104, 106 respectively, that includes an integral valance panel 100. The valance panels 100 extend downwardly from each of the top members 104, 106 over the panels 20 and 24. Alternatively, in a situation where the blinds 30 are drawn sideways instead of vertically, the valance panel may be located on a side of one or both of the frame halves.

The frame halves are typically connected together by a connection system 90 located on the interior surfaces 80, 82 of the frame halves 60, 62. One embodiment of the connection system is shown in FIGS. 1-3. In this embodiment, the outer frame half 62 includes a plurality of screw holes 110 on its interior surface 82, and the inner frame half 60 includes a plurality of screw bosses 112 that extend through the frame half 60. The frame halves 60 and 62 are connected by extending a screw 114 through the bosses 112 and into the holes 110. An alternative connection system is shown in FIGS. 4 and 5. This connection system is described in U.S. patent application Ser. No. 10/042,738, owned by ODL, Incorporated, which is the assignee of the present application. In short, this connection system eliminates the unsightly screws of the first embodiment. In this system, the interior surface 80 of the inner frame half 60 includes a plurality of prongs 120, and the interior surface 82 of the outer frame half 62 includes a plurality of receptacles 122. Each prong 120 is aligned with a receptacle 122 such that the halves can be joined together by inserting the prongs 120 into the receptacles 122. In an alternative embodiment (not shown) one or more of the non-decorative panels 20, 22, and 24 may be a smaller size in relation to the frame halves 60, 62, such that the interior surfaces 80, 82 extend over a smaller portion of the panels 20 and 24 than shown in FIG. 2. This hides the interior surfaces 80, 82 of the frame halves when looking through the assembly 10.

As shown in FIG. 2, the frame halves additionally connect the assembly 10 to a support structure 140, such as a wall or a door. Each frame half 60, 62 includes an outwardly extending finger 130, 132. The fingers 130, 132 are drawn together about the support structure 140 as the frame halves 60, 62 are connected to pinch the support structure between the fingers and attach the assembly 10 to the support structure 140.

III. Manufacture

Manufacture of the assembly 10 includes individual assembly of the blind 30 and the decorative panel 50, followed by assembling the three non-decorative panels 20, 22, 24 with the blind 30 and the decorative glass 50, and then connecting the frame halves 60, 62 about the first 20 and third 24 non-decorative panels. The decorative glass 50 is assembled by conventionally attaching the frame 58 to the perimeter of the decorative glass 50, and then attaching the spacer 66 to the perimeter of the frame 58. The spacer 66 may be molded about the frame 58, or otherwise conventionally attached. The blind 30 is also conventionally assembled. In short, the cords 36 and slats 38 are attached to the top rail 32 and the bottom rail 34 such that certain cords can be actuated to raise and lower the slats 38 and to rotate the slats 38 open and closed. The right and left spacers 40 and 42 are attached along the sides of the blind 30, and some of the cords 36 may be routed through one or both of the spacers.

After the individual assembly of the blind 30 and the decorative glass 50, these units may be attached to the non-decorative panels 20, 22, 24. In one embodiment, the decorative glass 50 is sandwiched between two of the panels, and sealed with an adhesive such as polysulfide. One side of the blind 30 is similarly attached to the third panel, and the other side of the blind 30 is attached to one of the panels surrounding the decorative panel 50. In another embodiment, the non-decorative panels may be attached to the blind 30 and the decorative panel 50 in any desirable order. The blind 30 and the decorative panel 50 are generally hermetically sealed between the non-decorative panels. The frame halves 60, 62 are then connected together about the perimeter of the first 20 and third 24 non-decorative panels such that the interior surfaces 80, 82 of the frame halves 60, 62 face the first 20 and third 24 non-decorative panels. In embodiments where the frame halves 60, 62 include a valance panel 100, the frame halves are attached such that the valance panels 100 will cover the blinds 30 when the blinds are in the raised position. The frame halves are connected by a known connection system, such as the prongs 120 and receptacles 122 shown in FIGS. 4 and 5. Finally, the frames 60, 62 may be connected to a desired support structure 140.

IV. Alternative Embodiments

FIG. 6 shows an alternative embodiment of the present invention, wherein the decorative panel 50 is replaced by a grid 150, the blind 30 is replaced by a shade assembly 130, and the valance panel is replaced by a valance 105 on the first glass panel 20.

Like the decorative glass 50, the grid 150 is a conventional decorative structure for window assemblies. The grid 150 includes a plurality of horizontal members 152 and a plurality of vertical members 154 that divide the viewing area into multiple sections. As shown in FIG. 6, the horizontal 152 and vertical 154 members may be positioned such that they are centered within the visible portion of the window assembly, for instance, the horizontal members 152 may be shifted down to accommodate for the portion of the assembly covered by the valance 100 or 105. The grid 150 is sandwiched between the second 22 and third panels 24, and may be sealed between them by an adhesive material such as polysulfide in a manner similar to the decorative panel.

The shade 130 is a conventional window covering, and therefore will not be described in great detail. Similar to the blind 30, the shade 130 includes a top rail (not shown), a bottom rail (not shown), and a plurality of cords extending between the rails. Instead of a plurality of slats, the shade 130 includes a shade material 132 that may raised and lowered to cover the window. As shown, the shade 130 includes pleats that fold in accordion fashion when raised. Alternatively the shade may be cellular or another known shade design. Like the blind, the shade may include spacers on the left and right sides, and an operator 44 to pull the shade 130 between the raised and lowered position. In one embodiment, the operator is connected to the cords such that the shade 130 moves completely from the lowered position to the raised position when the operator travels less than the full length of the track.

The shade 130 is sandwiched between the first 20 and second 22 non-decorative panels in the same way the blind 30 is attached, for instance, by an adhesive applied between the top rail, the left and right spacers, and the first and second panels 20 and 22. The shade 130 is preferably sealed to the first 20 and second 22 glass panels to form an airtight enclosure for the shade 130. The adhesive applied between the shade 130 and the panels 20 and 22 may be any adhesive known in the art such as a polysulfide adhesive.

The valance 105 is an alternative means for covering the raised blind 30 or shade 130. In the embodiment shown in FIG. 6, the valance 105 is formed by silk covering a portion of the first panel 20 and the third panel 24 with conventional silk screening. The second panel 22 may likewise be covered. Like the valance panel 100, the silk screened valance 105 includes a lower edge 107 that extends over the panels 20 and 24 a sufficient distance to hide the raised blinds 30 or shade 130. Alternatively, another known method may be applied or attached to the frames 60, 62, the panels 20, 22, or 24, or another part of the assembly 10 to hide the window covering when it is in a raised position.

FIG. 6 shows an embodiment wherein the assembly 10 includes a shade 130, a grid 150, and a silk screened valance 105, however, the assembly may include any combination of window covering, decorative structure and valance.

The above descriptions are those of current embodiments of the invention. Various alterations and changes can be made without departing from the spirit and broader aspects of the invention, which are to be interpreted in accordance with the principles of patent law including the Doctrine of Equivalents.

1. An window assembly, comprising:
first and second non-decorative glass panels sealed together;
a decorative structure sandwiched between said first and second non-decorative glass panels;
a third non-decorative glass panel sealed to said second glass panel; and
a window covering sandwiched between said second and third non-decorative glass panels.

2. The window assembly of claim 1 wherein said window covering includes a raised position and a lowered position, the assembly including a valance means that hides said window covering when said window covering is in said raised position.

3. The window assembly of claim 2 wherein said valance means is a silk screen applied to a portion of one of said first, second or third non-decorative panels.

4. The window assembly of claim 2 wherein said valance means is a valance panel on at least one of said frames.

5. The window assembly of claim 4 wherein said valance panel includes a bottom edge, and said decorative structure is a decorative panel that includes a top edge, a bottom edge, and a decoration, said decoration centered between said bottom edge of said valance panel and said bottom edge of said decorative panel.

6. The window assembly of claim 3 wherein said inner and outer frames each include a top member, a pair of side members, and a bottom member, said valance panel integral with said top member.

7. The window assembly of claim 6 further comprising a first spacer extending around a portion of said decorative panel, said first and second non-decorative panels sealed to said first spacer forming an airtight enclosure for said decorative panel.

8. The window assembly of claim 7 further comprising a second spacer extending around a portion of said window covering, said second and third non-decorative panels sealed to said second spacer forming an airtight enclosure for said window covering.

9. The window assembly of claim 8 wherein said first, second, and third non-decorative panels are sealed to said first and second spacers with polysulfide.

10. The window assembly of claim 3 wherein said decorative structure is a grid.

11. A window assembly comprising:
first and second glass panels;
a window covering sandwiched between said first and second glass panels, said window covering movable between a raised position and a lowered position; and
an inner frame and an outer frame supporting said glass panels, at least one of said frames being a single-piece including an integral, unitary valance panel that extends over a portion of one of said first and second panels, said valance panel covering said window covering when said window covering is in said raised position.

12. The window assembly of claim 11 further including a decorative structure and a third panel, said decorative structure sandwiched between said second and third panels, said first and second frames connected together about said first and third panels.

13. The window assembly of claim 12 wherein said decorative structure is a decorative panel that includes a decoration, said decoration particularly positioned on said decorative panel such that said decoration is centered within a visible portion of said decorative panel.

14. The window assembly of claim 13 including a first spacer between said first and second panels, said spacer sealed to said first and second panels to form an airtight enclosure for said window covering.

15. The window assembly of claim 14 including a second spacer between said second panel and said third panel, said second spacer sealed to said second and third panels to form an airtight enclosure for said decorative panel.

16. The window assembly of claim 15 wherein said first and second spacers are sealed to said first, second, and third panels with a polysulfide adhesive.

17. The window assembly of claim 16 wherein said valance panel is molded integrally with said at least one of said frames.

18. The window assembly of claim 17 wherein said first and second frames each include a top member, a pair of side members, and a bottom member, said valance panel included in said top member.

19. An insulated window assembly comprising:
a triple glazed assembly, comprising:
first and second non-decorative glass panels;
a decorative panel hermetically sealed between said first and second non-decorative panels, said decorative panel including a decoration;
a third non-decorative glass panel; and
a window covering hermetically sealed between said second and third glass panels, said window covering having a raised position and a lowered position; and
an inner frame and an outer frame supporting said triple glazed assembly; said frames each being a single-piece including an integral valance panel extending over a portion of said triple glazed assembly to cover said window covering when said window covering is in said raised position.

20. The insulated window assembly of claim 19 wherein said decorative panel includes a periphery, said decoration spaced from said periphery such that said valance panel does not extend over said decoration.

21. The insulated window assembly of claim 19 wherein said triple glazed assembly includes a first spacer between said first and second non-decorative panels and a second spacer between said second and third non-decorative panels, said first, second, and third panels sealed to said first and second spacers with a polysulfide sealant.

22. The insulated window assembly of claim 19 wherein said inner and outer frame each include a top member, said valance panels extending from said top member and including a bottom edge, and wherein said decorative panel includes a top edge covered by said valance panel and a bottom edge, said decoration centered on said decorative panel between said bottom edge of said valance panel and said bottom edge of said decorative panel.

23. The insulated window assembly of claim 19 wherein said second non-decorative panel defines a hole for equalizing air pressure within the assembly.

24. The insulated window assembly of claim 19 wherein said valance panels are molded integral with each of said inner and outer frames.

25. The insulated window assembly of claim 20 wherein said window covering is a blind.

26. The insulated window assembly of claim 19 wherein said window covering is a shade.
